(19) United States
(12) Patent Application Publication
(10) Pub. No.: US 2001/0003516 A1
(43) Pub. Date: Jun. 14, 2001

(54) Timepiece

(76) Inventor: Klaus Becker, Hong Kong (HK)

Correspondence Address: LEYDIG VOIT & MAYER, LTD, 700 THIRTEENTH ST. NW, SUITE 300, WASHINGTON, DC, 20005-3960, US

(21) Appl. No.: 09/729,772

(22) Filed: Dec. 6, 2000

(30) Foreign Application Priority Data
Dec. 13, 1999 (GB) 9929457.1

(51) Int. Cl. G04B 19/00

(52) U.S. Cl. 368/76

(57) ABSTRACT

A kit (100) of parts for assembly into a timepiece by a customer, which comprises a casing (112) formed with a front recess (120) having a bottom (122) for receiving a time face (130). An analogue and/or digital time movement is pre-assembled within the casing (112), which has a shaft (150) extending out through the recess bottom (122) for rotating hour/minute/second hands (152) to indicate time. The kit (100) includes a planar time face (130) having a size marginally smaller than that of the recess bottom (122) and formed with a central hole (32) for accommodating the shaft (150) when the time face (130) is received in the recess (120). A lens (140) is also supplied, for closing the recess (120). The kit (100) further includes a punch (60) for use by the customer to make a time face (130) from a print, said punch (60) incorporating a cutter (62) of a shape and size corresponding to that of the recess bottom (122).

The present invention relates to a kit of parts for assembly into a timepiece.

### BACKGROUND OF THE INVENTION

The face of a timepiece, such as a watch or clock, is an important part of the design, which however cannot usually be changed by a customer, nor is this intended by the manufacturer.

The invention seeks to mitigate or at least alleviate such a problem by providing a kit of parts for assembly into a timepiece having a face that can be changed or made by the customer.

### SUMMARY OF THE INVENTION

According to the invention, there is provided a kit of parts for assembly into a timepiece by a customer, comprising a casing formed with a front recess having a bottom for receiving a time face, a time movement pre-assembled within the casing and including a shaft extending out through the recess bottom, a plurality of time indicators for rotation by the shaft to indicate time, a planar time face having a size marginally smaller than that of the recess bottom and formed with a hole for accommodating the shaft when the time face is received in the recess, a lens for closing the recess, and a punch for use by said customer to make a time face from a print, said punch incorporating a cutter of a shape and size corresponding to that of the recess bottom.

Preferably, the kit of parts includes a template for use with the punch to facilitate the selection of the part of the print to be cut out as the time face.

More preferably, the template includes markers to identify the horizontal and vertical central axes with respect to the hole.

It is preferred that the time face is radially cut open for insertion laterally into the casing recess without being obstructed by the shaft.

It is further preferred that the time face is radially cut open to form a slit or slot.

Advantageously, a protrusion is formed on or adjacent the recess bottom, and the time face has a void at or adjacent its edge for engaging the protrusion, whereby the time face is held against turning.

It is preferred that the lens has a peripheral flange for holding the time face down against the recess bottom.

In a preferred embodiment, the kit of parts includes a computer storage medium storing a variety of software designs for printing to enable a customer to make a time face.

The kit of parts may include a printed paper or card prepared with pre-cut face segments or perforated time faces and respective centre holes.

The invention also provides a timepiece made from the aforesaid kit of parts.

### BRIEF DESCRIPTION OF DRAWINGS

The invention will now be more particularly described, by way of example only, with reference to the accompanying drawings, in which:

FIG. 1 is a side view of a first embodiment of a kit of parts for assembly into a timepiece in accordance with the invention, said kit including a face for the timepiece;

FIG. 2 is a side view of a second embodiment of a kit of parts for assembly into a timepiece in accordance with the invention, said kit including a face for the timepiece;

FIG. 3 is a fragmentary cross-sectional side view of a third embodiment of a kit of parts for assembly into a timepiece in accordance with the invention, said timepiece including a casing having a front recess, a face received in the recess and a lens closing the recess;

FIG. 4 is a fragmentary cross-sectional side view corresponding to FIG. 3, illustrating how the time face is fitted in the recess;

FIG. 5 is a top plan view showing three possible time faces for the kit of parts of FIG. 1, 2 or 3;

FIG. 6 is a side view of a paper punch for making the time faces of FIG. 5;

FIG. 7 is a top plan view of a template for use with the paper punch of FIG. 6 to facilitate the making of the time faces of FIG. 5;

FIG. 8 is a top plan view of a computer disc for storing various designs for making the time faces of FIG. 5; and

FIG. 9 is a top plan view of a paper sheet material from which the time faces of FIG. 5 may be made.

### DETAILED DESCRIPTION OF PREFERRED EMBODIMENTS

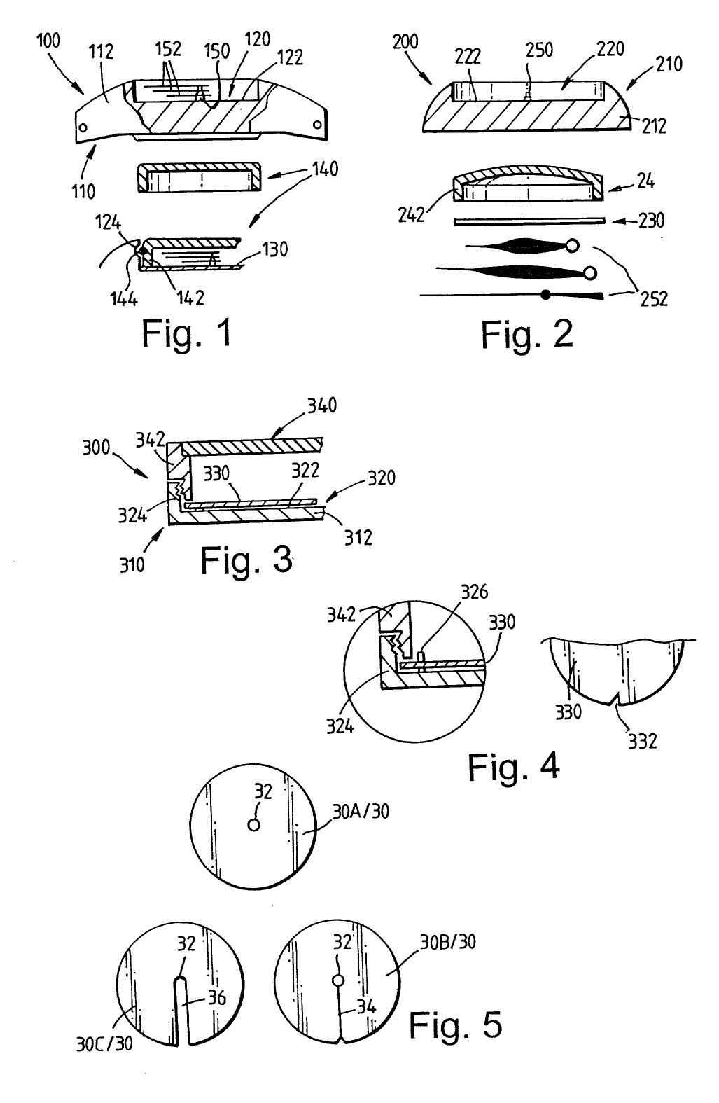

Referring initially to FIG. 1 of the drawings, there is shown a first kit 100 of parts for assembly into a wrist watch, embodying the invention, which kit 100 comprises a watch body 110 formed by a watch casing 112 and a time movement pre-assembled within the watch casing 112, a circular planar watch face 130 and a circular lens 140. The watch casing 112 is formed with a cylindrical front recess 120 having a flat bottom 122 for receiving the watch face 130. The time movement has a shaft 150 which extends out through the recess bottom 122 and includes hour, minute and second hands 152 mounted on the shaft 150 for rotation to indicate time.

The watch face 130 and lens 140 are to be sold as loose parts for assembly with the watch body 110 by a customer. The watch face 130 has a size marginally smaller than that of the recess bottom 122, for lying thereon. The lens 140 has a cylindrical peripheral flange 142 which may be provided with an O-ring 144 for engaging an annular groove 124 formed around the wall of the recess 120. This can also be an annular ledge or two or more noses. While the lens 140 is in place closing the recess 120, its flange 142 holds the watch face 130 down against the recess bottom 122.

Referring now to FIG. 2 of the drawings, there is shown a second kit 200 of parts for assembly into a clock, embodying the invention, which kit 200 comprises a clock body 210 formed by a clock casing 212 and a time movement pre-assembled within the clock casing 212, a circular planar clock face 230 and a circular lens 240. The clock casing 212 is formed with a cylindrical front recess 220 having a flat bottom 222 for receiving the clock face 230. The time movement has a shaft 250 which extends out through the recess bottom 222 and includes hour, minute and second hands 252 for mounting on the shaft 250 for rotation to indicate time.

The clock face 230, lens 240 and hands 252 are to be sold as loose parts for assembly with the clock body 210 by the customer. The clock face 230 is marginally smaller than the recess bottom 222, for lying thereon. The lens 240 has a cylindrical peripheral flange 242 for press-fit into and closing the recess 220. While the lens 240 is in place, its flange 242 holds the clock face 230 down against the recess bottom 222.

FIGS. 3 and 4 show certain parts of a third possible kit 300 of parts for assembly into a clock, embodying the invention, said parts (shown in the assembled condition) being a clock body 310 including a clock casing 312 formed with a front recess 320 having a flat bottom 322, a circular planar clock face 330 received in the recess bottom 322, and a circular lens 340 closing the recess 320. The recess 320 has a cylindrical wall 324 which is screw-threaded. The lens 340 incorporates a screw-threaded support frame 342 for engagement with the wall 324 in the recess 320. The bottom 322 of the recess 320 (or its wall 324) is formed with an upstanding pin 326 near the wall 324 (or a small protrusion adjoining the bottom 322, or an upstanding pin is fixed in the casing 312). The clock face 330 is cut to form a notch 332 at its edge (or a void or hole adjacent its edge) for engaging the pin 326, whereby the face 330 is held against turning by the lens 340 while the lens 340 is being screwed into the recess 320.

FIG. 5 shows three possible designs 30A, 30B and 30C (30 collectively) for the time face 130/230/330 of the kit 100/200/300 of parts described above. Each time face 30 is formed with a central hole 32 for accommodating the shaft of the time movement of the watch/clock body 110/210/310.

As the first time face 30A is not radially cut open, it may only be used in the clock body 210/310 of the second/third kit 200/300, in which the time-indicating hands are supplied as separate parts. Subsequent attachment of the hands onto the time movement shaft would not be too difficult for the customer because the hands are relatively large for a clock.

The second time face 30B is radially cut open, forming a slit 34 which extends from the central hole 32 right to the edge (where it is formed with a said notch 332). The third time face 30C is formed with a radial slot 36 which has a closed inner end acting as the central hole 32 and an open outer end at the edge (where it acts as a said notch 332). Either of these two faces 30B and 30C may be used also in the watch body 110 of the first kit 100, in which the time-indicating hands 152 (small in size for a watch) are supplied pre-attached onto the shaft 150. For use, the time face 30B or 30C is inserted laterally into the watch casing recess 120 between the time hands 152 and the recess bottom 122, with the slit 34 or slot 36 open for the shaft 150 to avoid obstruction.

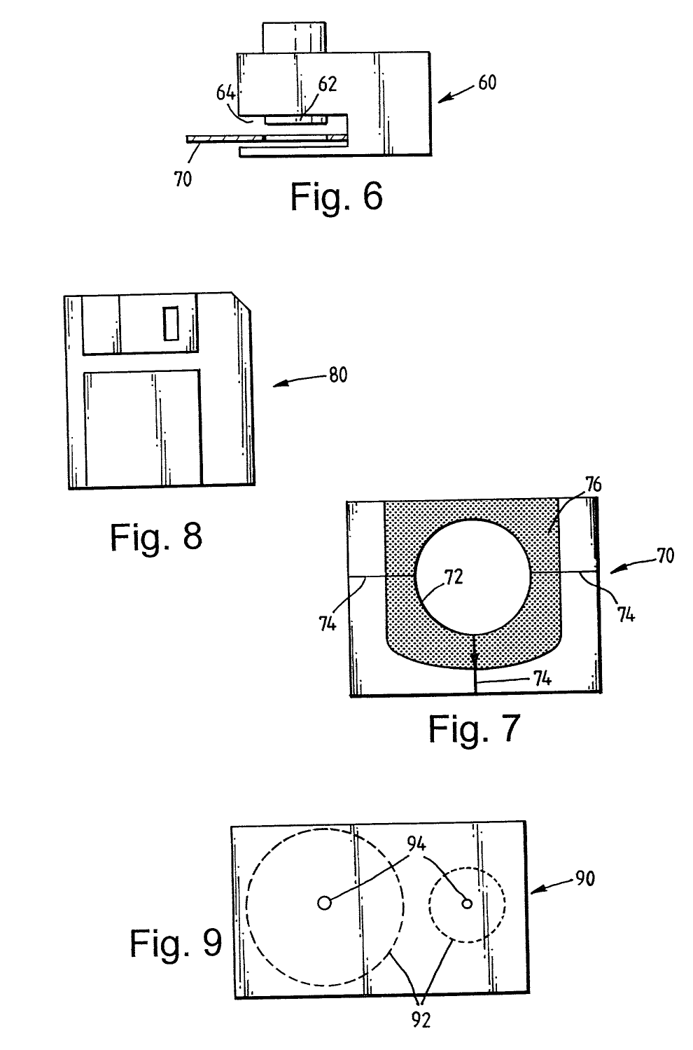

The time faces 30 may be printed with a certain graphic design and/or words (such as a trademark, slogan or message) , or may alternatively be made by the customer of his own choice as a cut-out from a print, such as a photograph, postcard or the like. For this purpose, a paper punch 60 is supplied as part of the kit 100/200/300, as shown in FIG. 6. The punch 60 incorporates a circular cutter 62 which has a size corresponding to that of the watch/clock casing recess 120/220/320 and preferably includes suitable cutting edge(s) for forming the aforesaid hole 32 and/or slit 34 or slot 36.

FIG. 7 shows an optional template 70 for use with the paper punch 60 to facilitate the selection of the part of the photograph to be cut out as the time face 30. The template 70 has a circular hole 72 which has the same diameter like the cutter 62 of the punch 60, and is marked with three lines 74 (as shown) to identify the horizontal and vertical central axes with respect to the hole 72. A shaded image 76 is printed around the hole 72, which has a shape matching with that of a cutting gap 64 of the punch 60. This image 76 serves to indicate the correct position for inserting the photograph into the punch gap 64 for cutting.

The kit 100/200/300 of parts may include a computer storage medium, such as a floppy disk 80 (FIG. 8), storing a variety of time face software designs for the customer to print on printing papers or cards 90 (FIG. 9) supplied also as part of the kit. The cards 90 are pre-cut with face segments or perforated time face circles 92 and respective central holes 94 for ready use.

It is envisaged that the time faces may be made of any other materials, such as plastics or metal, and that their shapes may not be circular, depending on the design of the timepiece body casing.

The subject kit of parts may be used for either an analogue, a digital or a combined analogue/digital timepiece. For a timepiece that has a digital time display, the time face of the subject kit should be cut to form a suitable hole for exposing the time display when in use.

The invention has been given by way of example only, and various other modifications of and/or alterations to the described embodiments may be made by persons skilled in the art without departing from the scope of the invention as specified in the appended claims.

What is claimed is:

1. A kit of parts for assembly into a timepiece by a customer, comprising a casing formed with a front recess having a bottom for receiving a time face, a time movement pre-assembled within the casing and including a shaft extending out through the recess bottom, a plurality of time indicators for rotation by the shaft to indicate time, a planar time face having a size marginally smaller than that of the recess bottom and formed with a hole for accommodating the shaft when the time face is received in the recess, a lens for closing the recess, and a punch for use by said customer to make a time face from a print, said punch incorporating a cutter of a shape and size corresponding to that of the recess bottom.

2. The kit of parts as claimed in claim 1, including a template for use with the punch to facilitate the selection of the part of the print to be cut out as the time face.

3. The kit of parts as claimed in claim 2, wherein the template includes markers to identify the horizontal and vertical central axes with respect to the hole.

4. The kit of parts as claimed in claim 1, wherein the time face is radially cut open for insertion laterally into the casing recess without being obstructed by the shaft.

5. The kit of parts as claimed in claim 4, wherein the time face is radially cut open to form a slit.

6. The kit of parts as claimed in claim 4, wherein the time face is radially cut open to form a slot.

7. The kit of parts as claimed in claim 1, wherein a protrusion is formed on or adjacent the recess bottom, and the time face has a void at or adjacent its edge for engaging the protrusion, whereby the time face is held against turning.

8. The kit of parts as claimed in claim 1, wherein the lens has a peripheral flange for holding the time face down against the recess bottom.

9. The kit of parts as claimed in claim 1, including a computer storage medium storing a variety of software designs for printing to enable a customer to make a time face.

10. The kit of parts as claimed in claim 1, including a printed paper or card prepared with pre-cut face segments or perforated time faces and respective centre holes.

11. A timepiece made from the kit of parts as claimed in claim 1.
